(19) United States
(12) Patent Application Publication
(10) Pub. No.: US 2026/0371398 A1
(43) Pub. Date: Nov. 19, 2026

(54) METHODS AND APPARATUSES FOR WAKING UP DEVICE, ELECTRONIC DEVICE, STORAGE MEDIUM, AND COMMUNICATION SYSTEM

(71) Applicant: BEIJING XIAOMI MOBILE SOFTWARE CO., LTD., Beijing (CN)

(72) Inventor: Ting FU, Beijing (CN)

(73) Assignee: BEIJING XIAOMI MOBILE SOFTWARE CO., LTD., Beijing (CN)

(21) Appl. No.: 19/128,227

(22) PCT Filed: Nov. 9, 2022
(86) PCT No.: PCT/CN2022/130978

§ 371 Date: May 8, 2025

(51) Int. Cl. H04W 74/0833; H04W 52/02; H04W 72/0453

(52) U.S. Cl. CPC H04W 74/0833; H04W 52/0235; H04W 72/0453

(57) ABSTRACT

A method for waking up a device is performed by a first network device and includes: sending a physical random access channel (PRACH) configuration of a second network device, where the PRACH configuration is used for sending, by user equipment on a PRACH channel of the second network device, information used for waking up the second network device.

### CROSS REFERENCE TO RELATED APPLICATION

This application is a National Stage of International Application No. PCT/CN2022/130978. filed on Nov. 9, 2022, which is incorporated by reference herein in its entirety for all purposes.

### TECHNICAL FIELD

The present disclosure relates to the field of communication technology, and in particular to methods, apparatuses, an electronic device, a storage medium, and a communication system for waking up a device.

### BACKGROUND

Reducing the energy consumption of network devices is one of the research directions in the mobile communication system, and one of the ways to reduce the energy consumption of network devices is to reduce unnecessary downlink transmission. For example, by keeping a network device in a dormant state, downlink transmission can be stopped or greatly reduced for the network device in the dormant state. When user equipment needs communication services, the dormant network device is woken up to provide communication services for the user equipment.

### SUMMARY

In order to overcome the problems existing in the related art, the present disclosure provides methods, apparatuses, an electronic device, a storage medium, and a communication system for waking up a device.

According to a first aspect of embodiments of the present disclosure, a method for waking up a device is provided, which is applied to a first network device and includes; sending a physical random access channel PRACH configuration of a second network device, where the PRACH configuration is used for sending, by user equipment on a PRACH channel of the second network device, information used for waking up the second network device.

According to a second aspect of embodiments of the present disclosure, a method for waking up a device is provided, which is applied to user equipment and includes: receiving a PRACH configuration of a second network device; and sending, according to the PRACH configuration, information used for waking up the second network device on a PRACH channel of the second network device.

According to a third aspect of embodiments of the present disclosure, a method for waking up a device is provided, which is applied to a second network device and includes: entering an awake state in response to receiving, in a dormant state, information used for waking up the second network device and sent, by user equipment according to a PRACH configuration of the second network device, on a PRACH channel of the second network device.

According to a fourth aspect of embodiments of the present disclosure, an apparatus for waking up a device is provided, which is provided at a first network device and includes: a configuration sending module, configured to send a physical random access channel PRACH configuration of a second network device, wherein the PRACH configuration is used for sending, by user equipment on a PRACH channel of the second network device. information used for waking up the second network device.

According to a fifth aspect of embodiments of the present disclosure, an apparatus for waking up a device is provided, which is provided at user equipment and includes: a configuration receiving module, configured to receive a PRACH configuration of a second network device; and an information sending module, configured to send, according to the PRACH configuration, information used for waking up the second network device on a PRACH channel of the second network device.

According to a sixth aspect of embodiments of the present disclosure, an apparatus for waking up a device is provided, which is provided at a second network device and includes: a device awakening module, configured to enter an awake state in response to receiving, in a dormant state, information used for waking up the second network device and sent, by user equipment according to a PRACH configuration of the second network device, on a PRACH channel of the second network device.

According to a seventh aspect of embodiments of the present disclosure, an electronic device is provided and includes: a processor; and a memory for storing executable instructions of the processor, where the processor is configured to, upon executing the instructions, implement the method according to the first aspect, the second aspect, or the third aspect.

According to an eighth aspect of embodiments of the present disclosure, a storage medium is provided and stores a computer program thereon, where the computer program is used for, upon being executed by a processor, implementing the method according to the first aspect, the second aspect, or the third aspect.

According to a ninth aspect of embodiments of the present disclosure, a communication system is provided and includes: user equipment, a first network device, and a second network device, where the first network device is configured to implement the method according to the first aspect; the user equipment is configured to implement the method according to the second aspect; and the second network device is configured to implement the method according to the third aspect.

In the above technical solution, the PRACH configuration of the second network device is sent through the first network device, so that the user equipment can obtain the PRACH configuration of the second network device when the second network device is in dormant state. The user equipment can send information for waking up the second network device on the PRACH channel of the second network device according to the PRACH configuration of the second network device, thereby waking up the second network device.

### BRIEF DESCRIPTION OF THE DRAWINGS

The accompanying drawings, which are incorporated in and constitute a part of this specification, illustrate some embodiments consistent with the present disclosure and. together with the description, serve to explain the principles of the present disclosure,

FIG. 1 is a schematic diagram illustrating a communication system according to an exemplary embodiment.

FIG. 2 is a flow chart illustrating a method for waking up a device according to an exemplary embodiment,

FIG. 3 is a flow chart illustrating a method for waking up a device according to an exemplary embodiment.

FIG. 4 is a flow chart illustrating a method for waking up a device according to an exemplary embodiment.

FIG. 5 is a flow chart illustrating a method for waking up a device according to an exemplary embodiment.

FIG. 6 is a flowchart illustrating a method for waking up a device according to an exemplary embodiment.

FIG. 7 is a flowchart illustrating a method for waking up a device according to an exemplary embodiment.

FIG. 8 is a flowchart illustrating a method for waking up a device according to an exemplary embodiment.

FIG. 9 is a flowchart illustrating a method for waking up a device according to an exemplary embodiment.

FIG. 10 is a flowchart illustrating a method for waking up a device according to an exemplary embodiment.

FIG. 11 is a flowchart illustrating a method for waking up a device according to an exemplary embodiment.

FIG. 12 is a flowchart illustrating a method for waking up a device according to an exemplary embodiment.

FIG. 13 is a flowchart illustrating a method for waking up a device according to an exemplary embodiment.

FIG. 14 is a flowchart illustrating a method for waking up a device according to an exemplary embodiment.

FIG. 15 is a flowchart illustrating a method for waking up a device according to an exemplary embodiment.

FIG. 16 is a flowchart illustrating a method for waking up a device according to an exemplary embodiment.

FIG. 17 is a schematic diagram illustrating an apparatus for waking up a device according to an exemplary embodiment.

FIG. 18 is a schematic diagram illustrating an apparatus for waking up a device according to an exemplary embodiment.

FIG. 19 is a schematic diagram illustrating an apparatus for waking up a device according to an exemplary embodiment.

FIG. 20 is a block diagram of an electronic device according to an exemplary embodiment.

FIG. 21 is a block diagram of an electronic device according to an exemplary embodiment.

### DETAILED DESCRIPTION

Exemplary embodiments will be described in detail herein, examples of which are shown in the accompanying drawings. When the following description refers to the drawings, unless otherwise indicated, the same numbers in different drawings represent the same or similar elements. The implementations described in the following exemplary embodiments do not represent all implementations consistent with the embodiments of the present disclosure. Instead, they are merely examples of apparatuses and methods consistent with some aspects of the embodiments of the present disclosure as detailed in the appended claims.

In the disclosed embodiments, in order to reduce the power consumption of a network device in a mobile communication system, the network device can enter a dormant state when a set dormancy condition is met, and the network device in the dormant state stops downlink transmission or only send a small amount of downlink information, such as only sending a downlink Discovery Reference Signal (DRS). The dormant network device still has an uplink receiving function. When the user equipment requires communication services, the dormant network device is awakened. After being awakened, the network device resumes normal receiving and sending functions to provide communication services for the user equipment.

In some implementations, the dormancy condition may include: the network device is not currently connected to any user equipment in the communication state.

In other implementations, the dormancy condition may include: the network device is not currently connected to any user equipment in the communication state, and the network device is within the coverage of another network device. For example, the network device may be a small base station. When the small base station determines that there is no user equipment in the communication state currently connected, and determines that it is within the coverage of a macro base station, it may enter the dormant state. After the small base station enters the dormant state, the macro base station still can provide communication services for this area to ensure normal communication of the user equipment.

Currently, there is no specific implementation method for waking up a network device in the related art. Therefore, embodiments of the present disclosure provide a method for waking up a device. The present disclosure is to be explained below in conjunction with the accompanying drawings.

The implementation environment of some embodiments of the present disclosure is first introduced below.

The technical solution according to some embodiments of the present disclosure can be applied to various communication systems, which may include one or more of 4G (the 4th Generation) communication system, 5G (the 5th Generation) communication system, and other future wireless communication systems (such as 6G),

FIG. 1 is a schematic diagram of a communication system according to an exemplary embodiment. As shown in FIG. 1, the communication system may include user equipment 101, a first network device 102, and a second network device 103. The communication system may be used to support 4G network access technology, such as Long Term Evolution (LTE) access technology; or 5G network access technology, such as New Radio Access Technology (New RAT); or other future wireless communication technologies. It should be noted that in the communication system, the number of the user equipment 101, the first network device 102, and the second network device 103 may be one or more, and the number of the user equipment 101, the first network device 102, and the second network device 103 in the communication system shown in FIG. 1 is only an adaptive example, and the present disclosure is not limited thereto.

The first network device 102 and the second network device 103 in FIG. 1 can be used as network devices to support access and communication services of the user equipment 101. For example, the first network device 102 and the second network device 103 can be evolutionary NodeB (eNB or eNodeB) in LTE, or the next generation NodeB (gNB or gNodeB) in 50 networks, or NG Radio Access Network (NG-RAN) devices in 50 networks, or base stations in future evolved public land mobile network (PLMN), broadband network gateway (BNG), aggregation switch, non-3GPP (3rd Generation Partnership Project) access device, or the like, Optionally, the first network device 102 and the second network device 103 in the embodiments of the present disclosure may be various forms of base stations, such as: macro base stations, small base stations, relay stations, access points, 5G base stations, or future base stations, satellites, Transmitting and Receiving Points (TRPs), Transmitting Points (TPs), mobile switching centers, and other devices that perform base station functions in communications of Device-to-Device (D2D), Machine-to-Machine (M2M), Internet of Things (IoT). Vehicle-to-Everything (V2X), or the like, and the embodiments of the present disclosure are not specifically limited thereto.

The User Equipment (UE) 101 in FIG. 1 may also be referred to as a user terminal, and may include but is not limited to a smart phone, a smart wearable device, a smart speaker, a smart tablet, a wireless modem, a Wireless Local Loop (WLL) station, a Personal Digital Assistant (PDA), a Customer Premise Equipment (CPE), or the like. With the development of wireless communication technology, devices that can access a communication system, communicate with network devices of the communication system, and communicate with other objects through the communication system can all be user equipment 101 in the embodiments of the present disclosure, including, for example, terminals and cars in smart transportation; household devices in smart homes; power meter reading instruments, voltage monitoring instruments, environmental monitoring instruments in smart grids; video monitoring instruments and cash registers in smart security networks; and the like. The user equipment 101 may be statically fixed or mobile, the present disclosure is not limited thereto. In the embodiments of the present disclosure, the user equipment 101 may communicate with the first network device 102 and the second network device 103.

It should be noted that the method for waking up a device provided in the embodiments of the present disclosure can be applicable to heterogeneous networks, in which, for example, a communication system provides communication services to the user equipment 101 in a networking mode of “macro base station +small base station”. Here, the macro base station is mainly used for outdoor coverage, with a wide coverage range; and a large number of small base stations are used to cooperate with the macro base station for continuous coverage and shallow indoor coverage. In some embodiments, the small base station includes but is not limited to a micro base station, a pico base station and a femto base station.

In the embodiments of the present disclosure, the first network device 102 may be a macro base station, and the second network device 103 may be a small base station within the coverage area of the macro base station.

In FIG. 1, the first network device 102 is used to send a physical random access channel (PRACH) configuration of the second network device 103. The user equipment 101 is used to send information for waking up the second network device 103 on the PRACH channel of the second network device 103 according to the PRACH configuration of the second network device 103 sent by the first network device 102. After receiving the wake-up information sent by the user equipment 101 on the PRACH channel, the second network device 103 enters the awake state from the dormant state, resumes normal sending and receiving functions, and provides communication services for the user equipment 101.

For more specific implementation process, the following related embodiments may be referred to.

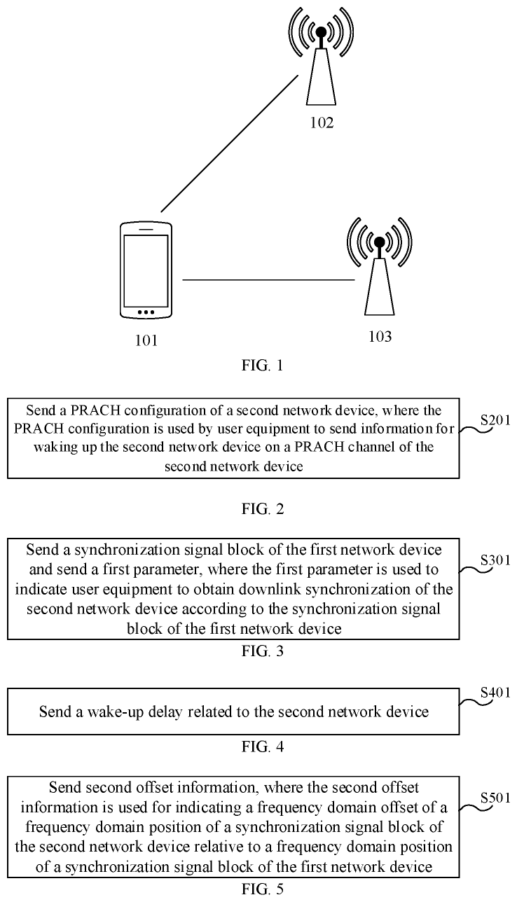

FIG. 2 is a flow chart of a method for waking up a device according to an exemplary embodiment, which is applied to a first network device, Referring to FIG. 2, the method includes the followings.

In S201, a PRACH configuration of a second network device is sent, where the PRACH configuration is used by user equipment to send information for waking up the second network device on a PRACH channel of the second network device.

In the above technical solution, the PRACH configuration of the second network device is sent through the first network device, so that the user equipment can obtain the PRACH configuration of the second network device when the second network device is in dormant state. The user equipment can send information for waking up the second network device on the PRACH channel of the second network device according to the PRACH configuration of the second network device, thereby waking up the second network device.

Optionally, the first network device may send the PRACH configuration of the second network device by in a broadcasting manner.

In an implementation, before sending the PRACH configuration of the second network device, the first network device may negotiate with the second network device about the PRACH configuration of the second network device.

The process of negotiating the PRACH configuration may be initiated by the second network device. For example, the second network device may carry a PRACH configuration when initiating the negotiation, and the first network device returns confirmation of the configuration. The second network device may carry multiple PRACH configurations when initiating the negotiation, and the first network device returns confirmation of one of the configurations.

The process of negotiating the PRACH configuration may also be initiated by the first network device. For example, the first network device may carry a PRACH configuration when initiating the negotiation, and the second network device may return confirmation of the configuration. Alternatively, the first network device may carry multiple PRACH configurations when initiating the negotiation, and the second network device may return confirmation of one of the configurations.

In some embodiments of the present disclosure, the PRACH configuration of the second network device may include at least one of the following:
a time domain resource of the PRACH channel of the second network device;
a frequency domain resource of the PRACH channel of the second network device;
a random access preamble sequence of the second network device.

For example, in some embodiments, the PRACH configuration of the second network device includes frequency domain resources of the PRACH channel of the second network device, where the frequency domain resources include first offset information, and the first offset information is used for indicating a frequency domain offset of a frequency domain starting position of the PRACH channel of the second network device relative to a common physical resource block 0 (common PRB0) of the first network device.

The first offset information enables the user equipment to determine the frequency domain starting position of the PRACH channel of the second network device according to the position of the common PRBO of the first network device when the second network device is in dormant state.

In addition, in the communication protocol, user equipment that is to access a cell may initiate random access by sending a random access preamble sequence on a PRACH channel of the network device. On this basis, in some embodiments, the PRACH configuration of the second network device may include a random access preamble sequence of the second network device. The number of random access preamble sequence(s) included in the PRACH configuration of the second network device may be one or more.

On this basis, the information for waking up the second network device sent by the user equipment on the PRACH channel of the second network device may include the random access preamble sequence in the PRACH configuration of the second network device.

In an example, when the PRACH configuration of the second network device includes multiple random access preamble sequences, the user equipment can select a random access preamble sequence from the multiple random access preamble sequences, and send the selected random access preamble sequence on the PRACH channel of the second network device. The random access preamble sequence is used as the information for waking up the second network device, and the second network device enters the awake state in response to receiving the corresponding random access preamble sequence on its own PRACH channel.

In the above technical solution, by reusing the random access preamble sequence in the communication protocol as the information for waking up the second network device, the process of waking up the device can be combined in the random access process during specific implementation, thereby being conducive for the second network device to quickly enter the random access process after being awakened, and being very convenient in actual deployment and implementation.

FIG. 3 is a flow chart of a method for waking up a device according to an exemplary embodiment, which is applied to a first network device. Referring to FIG. 3, the method includes the followings.

In S301, a synchronization signal block of a first network device is sent and a first parameter is sent, where the first parameter is used to instruct user equipment to obtain downlink synchronization of a second network device according to the synchronization signal block of the first network device.

In an implementation, on a synchronization channel, the first network device broadcasts the synchronization signal block, such as Synchronization Signal and PBCH block (SSB) and broadcasts the first parameter.

In the above technical solution, the synchronization signal block of the first network device is sent through the first network device, and the first parameter is sent through the first network device, so that after receiving the synchronization signal block and the first parameter sent by the first network device, the user equipment can obtain the downlink synchronization of the second network device according to the first parameter and the synchronization signal block of the first network device, thereby facilitating sending of the information for waking up the second network device on the PRACH channel of the second network device according to the downlink synchronization of the second network device.

It is understandable that when the second network device is in the dormant state, the second network device usually no longer broadcasts its own synchronization signal block (SSB), so the user equipment cannot directly obtain the downlink synchronization of the second network device through the synchronization signal block of the second network device. However, through the synchronization signal block and the first parameter sent by the first network device, the user equipment can obtain the downlink synchronization of the second network device when the second network device is in the dormant state.

In some embodiments of the present disclosure, the user equipment may first obtain downlink synchronization of the first network device according to the synchronization signal block of the first network device, and then obtain downlink synchronization of the second network device according to the downlink synchronization of the first network device and the first parameter.

In some embodiments of the present disclosure, the first parameter is used for indicating that the downlink timing of the second network device is the same as that of the first network device, or is used for indicating the downlink timing difference between the second network device and the first network device.

For example, when the first parameter is used for indicating that the downlink timing of the second network device is the same as that of the first network device, the user equipment may use the downlink synchronization of the first network device as the downlink synchronization of the second network device.

For example, when the first parameter is used for indicating the downlink timing time difference between the second network device and the first network device, the user equipment can obtain the downlink synchronization of the second network device based on the downlink synchronization of the first network device and the downlink timing time difference between the second network device and the first network device indicated by the first parameter.

FIG. 4 is a flow chart of a method for waking up a device according to an exemplary embodiment, which is applied to a first network device. Referring to FIG. 4, the method includes the followings.

In S401, a wake-up delay for a second network device is sent.

The wake-up delay is used for indicating the delay from when the user equipment sends the information for waking up the second network device to when the user equipment receives the synchronization signal block sent by the second network device.

In an implementation, the user equipment receives the wake-up delay for the second network device sent by the first network device, and starts timing after sending the information for waking up the second network device. If a synchronization signal block sent by the second network device is not received within the corresponding wake-up delay, other corresponding measures can be attempted for wake-up, such as increasing the uplink transmission power or changing to another second network device.

By sending the wake-up delay of the second network device, the user equipment can take other corresponding measures when the second network device fails to wake up after timing expiration, so as to avoid waiting for a long time for the synchronization signal block of the second network device.

FIG. 5 is a flow chart of a method for waking up a device according to an exemplary embodiment, which is applied to a first network device. Referring to FIG. 5, the method includes the followings.

In S501, second offset information is sent, where the second offset information is used for indicating a frequency domain offset of a frequency domain position of a synchronization signal block of the second network device relative to a frequency domain position of a synchronization signal block of the first network device.

By sending the second offset information, the user equipment can determine the frequency domain position of the synchronization signal block of the second network device according to the frequency domain position of the synchronization signal block of the first network device and the frequency domain offset indicated by the second offset information. This facilitates the user equipment to directly monitor the synchronization signal block of the second network device at the corresponding frequency domain position after the second network device is awakened, without the need for the user equipment to search for the synchronization signal block in different frequency domains.

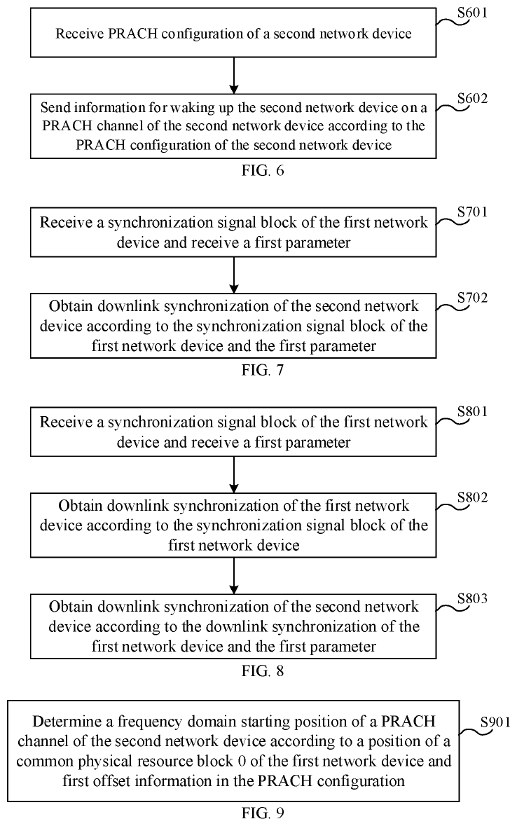

FIG. 6 is a flow chart of a method for waking up a device according to an exemplary embodiment, which is applied to user equipment. Referring to FIG. 6, the method includes the followings.

In S601, PRACH configuration of a second network device is received.

In S602, information for waking up the second network device is sent on a PRACH channel of the second network device according to the PRACH configuration of the second network device.

In the above technical solution, the user equipment receives the PRACH configuration of the second network device, and sends, according to the PRACH configuration of the second network device, the information for waking up the second network device on the PRACH channel of the second network device, thereby waking up the second network device.

Optionally, the first network device may send the PRACH configuration of the second network device in a broadcasting manner, so the user equipment may receive the PRACH configuration of the second network device broadcasted by the first network device.

FIG. 7 is a flow chart of a method for waking up a device according to an exemplary embodiment, which is applied to user equipment. Referring to FIG. 7, the method includes the followings.

In S701, a synchronization signal block of the first network device is received and a first parameter is received.

In S702, downlink synchronization of the second network device is obtained according to the synchronization signal block of the first network device and the first parameter.

In an implementation, the first network device broadcasts the synchronization signal block, such as SSB, and broadcasts the first parameter on the synchronization channel, so that the user equipment can receive the synchronization signal block and the first parameter broadcast by the first network device.

In the above technical solution, the user equipment can obtain downlink synchronization of the second network device through the first parameter and the synchronization signal block of the first network device.

FIG. 8 is a flow chart of a method for waking up a device according to an exemplary embodiment, which is applied to user equipment, Referring to FIG. 8, the method includes the followings.

In S801, a synchronization signal block of the first network device is received and a first parameter is received.

In S802, downlink synchronization of the first network device is obtained according to the synchronization signal block of the first network device.

In S803, downlink synchronization of the second network device is obtained according to the downlink synchronization of the first network device and the first parameter.

In the above technical solution, the user equipment can first obtain the downlink synchronization of the first network device according to the synchronization signal block of the first network device, and then obtain the downlink synchronization of the second network device according to the downlink synchronization of the first network device and the first parameter.

In some embodiments, the first parameter is used for indicating that the downlink timing of the second network device is the same as that of the first network device, or is used for indicating a downlink timing difference between the second network device and the first network device.

For example, the first parameter is used for indicating that the downlink timing of the second network device is the same as that of the first network device.

In such case, in step S803, the user equipment may use the downlink synchronization of the first network device as the downlink synchronization of the second network device.

For example, the first parameter is used for indicating the downlink timing difference between the second network device and the first network device.

In such case, in step S803, the user equipment may obtain downlink synchronization of the second network device according to the downlink synchronization of the first network device and the downlink timing difference between the second network device and the first network device indicated by the first parameter.

Through indication of the first parameter and the synchronization signal block of the first network device, when the second network device is in the dormant state, the user equipment can obtain downlink synchronization of the second network device.

On the basis of obtaining downlink synchronization of the second network device, the user equipment may send the information for waking up the second network device on a PRACH channel of the second network device.

In some embodiments of the present disclosure, the PRACH configuration of the second network device may include at least one of the following:
a time domain resource of the PRACH channel of the second network device;
a frequency domain resource of the PRACH channel of the second network device;
a random access preamble sequence of the second network device.

For example, in some embodiments, the PRACH configuration of the second network device includes frequency domain resources of the PRACH channel of the second network device, where the frequency domain resources include first offset information, and the first offset information is used for indicating a frequency domain offset of a frequency domain starting position of the PRACH channel of the second network device relative to a common physical resource block 0 (common PRB0) of the first network device.

FIG. 9 is a flow chart of a method for waking up a device according to an exemplary embodiment, which is applied to user equipment. Referring to FIG. 9, the method includes the followings.

In S901, a frequency domain starting position of a PRACH channel of the second network device is determined according to a position of a common PRB0 of the first network device and first offset information in the PRACH configuration.

Specifically, after receiving the synchronization signal block of the first network device, the user equipment can determine the position of common PRB0 of the first network device according to the synchronization signal block of the first network device, and then determine the frequency domain starting position of the PRACH channel of the second network device according to the position of common PRB0 of the first network device and the first offset information in the above-mentioned PRACH configuration.

By using the first offset information, the user equipment can determine the frequency domain starting position of the PRACH channel of the second network device when the second network device is in the dormant state.

In addition, in the communication protocol, user equipment that is to access a cell may initiate random access by sending a random access preamble sequence on a PRACH channel of the network device. On this basis, in some embodiments, the PRACH configuration of the second network device may include a random access preamble sequence of the second. network device. The number of random access preamble sequence(s) included in the PRACH configuration of the second network device may be one or more.

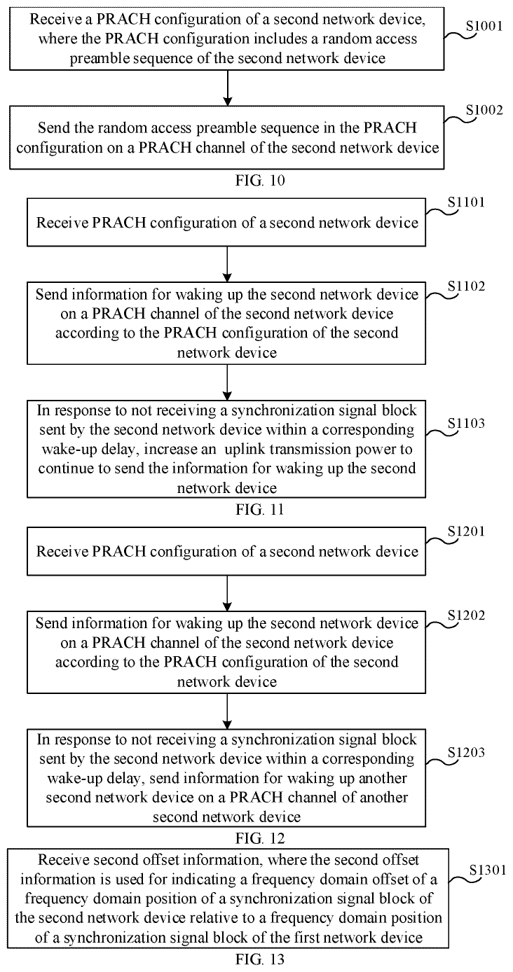

FIG. 10 is a flow chart of a method for waking up a device according to an exemplary embodiment, which is applied to user equipment, Referring to FIG. 10, the method includes the followings.

In S1001, a PRACH configuration of the second network device is received. where the PRACH configuration includes a random access preamble sequence of the second network device.

In S1002, a random access preamble sequence in the PRACH configuration is sent on a PRACH channel of the second network device.

In an example, when the PRACH configuration of the second network device includes multiple random access preamble sequences, the user equipment can select a random access preamble sequence from the multiple random access preamble sequences, and send the selected random access preamble sequence on the PRACH channel of the second network device. The random access preamble sequence is used as the information for waking up the second network device, and the second network device enters the awake state in response to receiving the corresponding random access preamble sequence on its own PRACH channel. A random access process can then be performed.

In the above technical solution, by reusing the random access preamble sequence in the communication protocol as the information for waking up the second network device, the process of waking up the device can be combined in the random access process during specific implementation, thereby being conducive for the second network device to quickly enter the random access process after being awakened, and being very convenient in actual deployment and implementation.

FIG. 11 is a flow chart of a method for waking up a device according to an exemplary embodiment, which is applied to user equipment. Referring to FIG. 11, the method includes the followings.

In S1101, PRACH configuration of the second network device is received.

In S1102, information for waking up the second network device is sent on a PRACH channel of the second network device according to the PRACH configuration of the second network device.

In some embodiments, the information for waking up the second network device may include a random access preamble sequence in the PRACH configuration of the second network device.

In S1103, in response to not receiving a synchronization signal block sent by the second network device within a corresponding wake-up delay, the uplink transmission power is increased to continue sending the information for waking up the second network device.

In the above technical solution, after the user equipment sends the information for waking up the second network device on the PRACH channel of the second network device, if the synchronization signal block sent by the second network device is not received within the wake-up delay corresponding to the second network device, the uplink transmission power is increased to continue sending information to continue to wake up the second network device.

FIG. 12 is a flow chart of a method for waking up a device according to an exemplary embodiment, which is applied to user equipment. Referring to FIG. 12, the method includes the followings.

In S1201, PRACH configuration of the second network device is received.

In S1202, information for waking up the second network device is sent on a PRACH channel of the second network device according to the PRACH configuration of the second network device.

In S1203, in response to not receiving a synchronization signal block sent by the second network device within a corresponding wake-up delay, information for waking up another second network device is sent on a PRACH channel of another second network device.

In the above technical solution, after the user equipment sends information for waking up the second network device on the PRACH channel of the second network device, if the synchronization signal block sent by the second network device is not received within the wake-up delay corresponding to the second network device, then it can change to sending information for waking up another second network device on the PRACH channel of another second network device.

In an implementation, the first network device may send PRACH configurations corresponding to multiple second network devices, and the user equipment may select the PRACH configuration of one of the second network devices, and send information for waking up the selected second network device on the PRACH channel corresponding to the selected second network device according to the PRACH configuration of the selected second network device. If the synchronization signal block sent by this second network device is not received within the wake-up delay corresponding to this second network device, the PRACH configuration of another second network device may be reselected, and information for waking up the another second network device may be sent on the PRACH channel of the another second network device according to the PRACH configuration of the newly selected another second network device.

On this basis, the first network device may also send first parameters corresponding to multiple second network devices. In this way, if the user equipment reselects another second network device, the downlink synchronization of the another second network device may be obtained according to the first parameter of the another second network device. The user equipment may send information for waking up the another second network device on the PRACH channel of the another second network device based on obtaining the downlink synchronization of the another second network device.

It is understandable that the wake-up delays corresponding to the second network devices may be the same or different. For example, a unified wake-up delay is agreed upon in the communication protocol, or the first network device configures different wake-up delays for different second network devices.

In FIG. Il and FIG. 12, the wake-up delay may be agreed upon in the communication protocol.

In FIG. 11 and FIG. 12, the wake-up delay may be sent by the first network device.

Accordingly, the method for waking up the device may further include:
receiving a wake-up delay for the second network device sent by the first network device.

It can be understood that the wake-up delay agreed in the communication protocol or sent by the first network device allows the user equipment to take other corresponding measures when the second network device fails to be woke up after timing expiration, so as to avoid waiting for a long time for the synchronization signal block of the second network device.

FIG. 13 is a flow chart of a method for waking up a device according to an exemplary embodiment, which is applied to user equipment. Referring to FIG. 13, the method includes the followings.

In S1301, second offset information is received, where the second offset information is used for indicating a frequency domain offset of a frequency domain position of a synchronization signal block of the second network device relative to a frequency domain position of a synchronization signal block of a first network device.

By receiving the second offset information, the user equipment can determine the frequency domain position of the synchronization signal block of the second network device according to the indication of the second offset information.

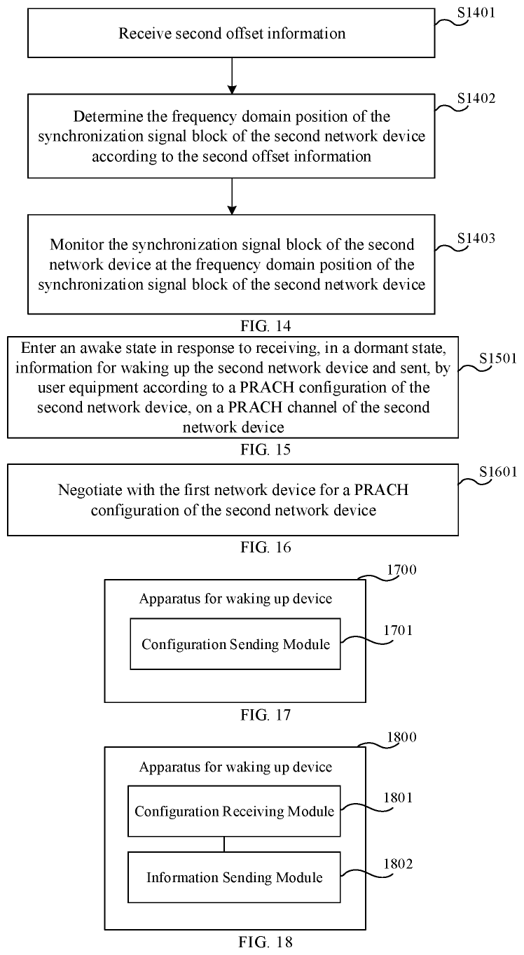

FIG. 14 is a flow chart of a method for waking up a device according to an exemplary embodiment, which is applied to user equipment. Referring to FIG. 14, the method includes the followings.

In S1401, second offset information is received.

In S1402: the frequency domain position of the synchronization signal block of the second network device is determined according to the second offset information.

In S1403, the synchronization signal block of the second network device is monitored at the frequency domain position of the synchronization signal block of the second network device.

By receiving the second offset information, the user equipment can determine the frequency domain position of the synchronization signal block of the second network device based on the frequency domain position of the synchronization signal block of the first network device and the frequency domain offset indicated by the second offset information, so that the user equipment can directly monitor the synchronization signal block of the second network device at the corresponding frequency domain position without necessity of the user equipment to search for the synchronization signal block in different frequency domains.

FIG. 15 is a flow chart of a method for waking up a device according to an exemplary embodiment, which is applied to a second network device. Referring to FIG. 15, the method includes the followings.

In S1501, in response to receiving information for waking up the second network device in a dormant state, which is sent by user equipment on a PRACH channel of the second network device according to a PRACH configuration of the second network device, an awake state is entered.

In an example, the second network device can enter the dormant state when a set dormancy condition is met. The second network device in the dormant state stops downlink transmission or only sends a small amount of downlink information, such as only sending downlink DRS. The second network device in the dormant state has an uplink receiving function and can receive a wake-up signal sent uplink by the user equipment.

In the above technical solution, the second network device can respond to the wake-up information sent by the user equipment on the PRACH channel, enter the awake state from the dormant state, resume the normal transceiver function, and provide communication services for the user equipment.

After entering the awake state, the second network device will resume normal transceiver functions, so the second network device can normally broadcast a synchronization signal block (SSB) on the synchronization channel.

Accordingly, the method further includes: sending a synchronization signal block after entering the awake state.

Optionally, the user equipment can detect whether the synchronization signal block sent by the second network device is received within a corresponding wake-up delay based on the wake-up delay corresponding to the second network device. If the synchronization signal block sent by the second network device is not received within the corresponding wake-up delay, the uplink transmission power is increased accordingly and sending is repeated; or information for waking up another second network device is sent on a PRACH channel of the another second network device.

Optionally, the user equipment may monitor the synchronization signal block of the second network device at the frequency domain position of the synchronization signal block of the second network device according to the frequency domain position of the synchronization signal block of the second network device.

In some embodiments of the present disclosure, the PRACH configuration of the second network device may include at least one of the following:
a time domain resource of the PRACH channel of the second network device; a frequency domain resource of the PRACH channel of the second network device;
a random access preamble sequence of the second network device.

In some embodiments, the information for waking up the second network device may include the random access preamble sequence in the PRACH configuration of the second network device.

In the above technical solution, by reusing the random access preamble sequence in the communication protocol as the information for waking up the second network device, the process of waking up the device can be combined in the random access process during specific implementation, thereby being conducive for the second network device to quickly enter the random access process after being awakened, and being very convenient in actual deployment and implementation.

FIG. 16 is a flow chart of a method for waking up a device according to an exemplary embodiment, which is applied to a second network device. Referring to FIG. 16, the method includes the followings.

In S1601, negotiation is performed with the first network device for the PRACH configuration of the second network device.

In an example, the second network device may negotiate with the first network device about the PRACH configuration of the second network device.

The process of negotiating the PRACH configuration may be initiated by the second network device. For example, the second network device may carry a PRACH configuration when initiating the negotiation, and the first network device returns confirmation of the configuration. The second network device may carry multiple PRACH configurations when initiating the negotiation, and the first network device returns confirmation of one of the configurations.

The process of negotiating the PRACH configuration may also be initiated by the first network device. For example, the first network device may carry a PRACH configuration when initiating the negotiation, and the second network device may return confirmation of the configuration. Alternatively, the first network device may carry multiple PRACH configurations when initiating the negotiation, and the second network device may return confirmation of one of the configurations.

In an exemplary embodiment, the second network device may, based on the PRACH configuration of the second network device, consider that a wake-up signal corresponding to itself is received when a corresponding random access preamble sequence is detected on the time-frequency resources of the PRACH channel, and enter the awake state.

In addition, the specific process for the user equipment to obtain the PRACH configuration of the second network device, the specific process for obtaining the downlink synchronization of the second network device, the specific process for obtaining the wake-up delay of the second network device, and the specific process for obtaining the frequency domain position of the synchronization signal block of the second network device have been described in the relevant embodiments above and will not be repeated here.

The following uses an example in which the first network device is a macro base station and the second network device is a small base station within the coverage area of the macro base station to illustrate the technical solution.

In the present disclosure, first, the macro base station broadcasts at least one PRACH configuration, with each PRACH configuration corresponding to at least one small base station within the coverage of the macro base station, Each PRACH configuration includes time domain resources, frequency domain resources of the PRACH channel of a corresponding small base station and the random access preamble sequence of the small base station. It can be understood that when the random access preamble sequences, as well as the time domain resources and frequency domain resources of the PRACH channels of multiple small base stations are the same, one PRACH configuration can correspond to these multiple small base stations at the same time.

Prior to this, the macro base station may negotiate with each small base station respectively on the PRACH configuration of the small base station. The process of negotiating the PRACH configuration may be initiated by the macro base station or by the small base station. For the specific negotiation process, the above description can be referred to.

In addition, the macro base station also broadcasts SSB and at least one first parameter, where the first parameter is used to instruct the user equipment to obtain the downlink synchronization of the corresponding small base station according to the SSB of the macro base station. The first parameter can indicate that the downlink timing of the small base station is the same as that of the macro base station, or indicate the downlink timing time difference between the small base station and the macro base station. The first parameter can be configured as more than one, with each first parameter corresponding to one small base station.

Then, the user equipment first obtains the downlink synchronization of the macro base station according to the SSB of the macro base station, and then obtains the downlink synchronization of the small base station according to the first parameter.

Then, the user equipment sends the configured random access preamble sequence on the corresponding PRACH channel according to one of the PRACH configurations broadcast by the macro base station to wake up the corresponding small base station. After being woke up, the small base station will broadcast SSB on the synchronization channel.

In addition, the macro base station can also configure corresponding wake-up delays for each small base station. If the user equipment does not receive SSB of a corresponding small base station within the wake-up delay after sending the random access preamble sequence, it can increase the uplink transmit power and send the configured random access preamble sequence again; or instead send the random access preamble sequence configured for another small base station on the PRACH channel of the another small base station.

It should be understood that since the user equipment has previously obtained the PRACH configurations and first parameters corresponding to each small base station broadcast by the macro base station, it can easily obtain the PRACH configuration and downlink synchronization of another small base station.

In some embodiments, when the macro base station configures the frequency domain resources of the PRACH channel of each small base station, the frequency domain resources include first offset information, and the first offset information is used for indicating the frequency domain offset of the frequency domain starting position of the PRACH channel of a corresponding small base station relative to common physical resource block 0 of the macro base station, so that the user equipment can determine the frequency domain starting position of the PRACH channel of the corresponding small base station.

In some embodiments, the macro base station can also configure second offset information of the frequency domain position of SSB of each small base station relative to the frequency domain position of SSB of the macro base station. This makes it convenient for the user equipment to directly monitor the SSB of the small base station at the corresponding frequency domain position after the small base station is awakened, without having to search for SSB in different frequency domains.

FIG. 17 is a schematic diagram of an apparatus for waking up a device according to an exemplary embodiment, which is provided in a first network device. Referring to FIG. 17, the apparatus 1700 for waking up a device includes:
a configuration sending module 1701, configured to send a PRACH configuration of a second network device, where the PRACH configuration is used for sending, by user equipment on a PRACH channel of the second network device, information for waking up the second network device.

In the above technical solution, the PRACH configuration of the second network device is sent by the first network device, so that the user equipment can obtain the PRACH configuration of the second network device when the second network device is in the dormant state, so that the user equipment can send information for waking up the second network device on the PRACH channel of the second network device according to the PRACH configuration of the second network device, thereby waking up the second network device.

In some embodiments, the apparatus 1700 further includes:
a parameter sending module, configured to send a synchronization signal block of the first network device and a first parameter, where the first parameter is used to instruct the user equipment to obtain downlink synchronization of the second network device according to the synchronization signal block of the first network device.

In some embodiments, the first parameter is used for indicating that the downlink timing of the second network device is the same as that of the first network device, or is used for indicating the downlink timing difference between the second network device and the first network device.

In some embodiments, the PRACH configuration includes at least one of:
a time domain resource of the PRACH channel of the second network device;
a frequency domain resource of the PRACH channel of the second network device;
a random access preamble sequence of the second network device.

In some embodiments, the PRACH configuration includes frequency domain resources of the PRACH channel of the second network device, where the frequency domain resources include first offset information, and the first offset information is used for indicating the frequency domain offset of the frequency domain starting position of the PRACH channel of the second network device relative to the common physical resource block 0 of the first network device.

In some embodiments, the PRACH configuration includes a random access preamble sequence of the second network device, and the information for waking up the second network device includes the random access preamble sequence.

In some embodiments, the apparatus 1700 further includes:
a delay sending module, configured to send a wake-up delay for the second network device.

In some embodiments, the apparatus 1700 further includes:
an offset information sending module, configured to send second offset information, where the second offset information is used for indicating the frequency domain offset of the frequency domain position of the synchronization signal block of the second network device relative to the frequency domain position of the synchronization signal block of the first network device.

In some embodiments, the first network device is a macro base station, and the second network device is a small base station within the coverage area of the macro base station.

FIG. 18 is a schematic diagram of an apparatus for waking up a device according to an exemplary embodiment, which is provided in user equipment. Referring to FIG. 18, the apparatus 1800 for waking up a device includes:
a configuration receiving module 1801, configured to receive a PRACH configuration of a second network device; and
an information sending module 1802, configured to send information for waking up the second network device on the PRACH channel of the second network device according to the PRACH configuration.

In the above technical solution, the user equipment receives the PRACH configuration of the second network device, and sends, according to the PRACH configuration of the second network device, information for waking up the second network device on the PRACH channel of the second network device, thereby waking up the second network device.

In some embodiments, the apparatus 1800 further includes:
a parameter receiving module, configured to receive a synchronization signal block of a first network device and receive a first parameter; and
a downlink synchronization module, configured to obtain downlink synchronization of the second network device according to the synchronization signal block of the first network device and the first parameter.

In some embodiments, the downlink synchronization module includes:
a first synchronization module, configured to obtain downlink synchronization of the first network device according to a synchronization signal block of the first network device; and
a second synchronization module, configured to obtain the downlink synchronization of the second network device according to the downlink synchronization of the first network device and the first parameter.

In some embodiments, the first parameter is used for indicating that the downlink timing of the second network device is the same as that of the first network device.

In some embodiments, the second synchronization module is configured to use the downlink synchronization of the first network device as the downlink synchronization of the second network device.

In some embodiments, the first parameter is used for indicating a downlink timing difference between the second network device and the first network device.

In some embodiments, the second synchronization module is configured to obtain the downlink synchronization of the second network device according to the downlink synchronization of the first network device and the downlink timing time difference between the second network device and the first network device indicated by the first parameter.

In some embodiments, the PRACH configuration includes at least one of:
a time domain resource of the PRACH channel of the second network device;
a frequency domain resource of the PRACH channel of the second network device;
a random access preamble sequence of the second network device.

In some embodiments, the PRACH configuration includes frequency domain resources of the PRACH channel of the second network device, where the frequency domain resources include first offset information, and the first offset information is used for indicating the frequency domain offset of the frequency domain starting position of the PRACH channel of the second network device relative to the common physical resource block 0 of the first network device.

In some embodiments, the apparatus 1800 further includes:
a first frequency domain determination module, configured to determine the frequency domain starting position of the PRACH channel of the second network device according to the position of the common physical resource block 0 of the first network device and the first offset information in the PRACH configuration.

In some embodiments, the PRACH configuration includes a random access preamble sequence of the second network device; and the information sending module 1802 is configured to send the random access preamble sequence in the PRACH configuration on the PRACH channel of the second network device.

In some embodiments, the apparatus 1800 further includes:
a wake-up detection module, configured to, in response to not receiving a synchronization signal block sent by the second network device within a corresponding wake-up delay after the information sending module 1802 sends the information for waking up the second network device, increase the uplink transmission power and continue to send the information for waking up the second network device.

In some embodiments, the apparatus 1800 further includes:
a wake-up detection module, configured to, in response to not receiving a synchronization signal block sent by the second network device within a corresponding wake-up delay after the information sending module 1802 sends the information for waking up the second network device, send information for waking up another second network device on a PRACH channel of the another second network device.

In some embodiments, the wake-up delay is agreed upon in the communication protocol.

In some embodiments, the apparatus 1800 further includes:
a delay receiving module, configured to receive the wake-up delay for the second network device sent by the first network device.

In some embodiments, the apparatus 1800 further includes:
an offset information receiving module, configured to receive second offset information, where the second offset information is used for indicating the frequency domain offset of the frequency domain position of the synchronization signal block of the second network device relative to the frequency domain position of the synchronization signal block of the first network device.

In some embodiments, the apparatus 1800 further includes:
a second frequency domain determination module, configured to determine a frequency domain position of a synchronization signal block of the second network device according to the second offset information; and
a monitoring module, configured to monitor the synchronization signal block of the second network device at the frequency domain position of the synchronization signal block of the second network device.

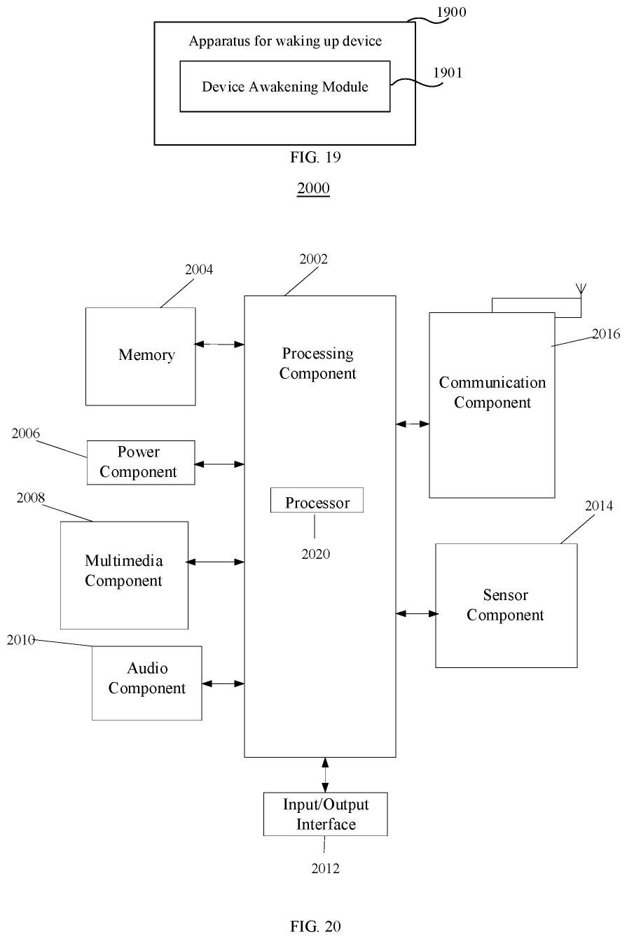

FIG. 19 is a schematic diagram of an apparatus for waking up a device according to an exemplary embodiment, which is provided in user equipment. Referring to FIG. 19, the apparatus 1900 for waking up a device includes:
a device awakening module 1901, configured to enter an awake state in response to receiving, in a dormant state, information configured to wake up the second network device and sent, by user equipment according to a PRACH configuration of the second network device, on a PRACH channel of the second network device.

In the above technical solution, the second network device can respond to the wake-up information sent by the user equipment on the PRACH channel, enter the awake state from the dormant state, resume the normal transceiver function, and provide communication services for the user equipment.

In some embodiments, the information for waking up the second network device includes a random access preamble sequence in the PRACH configuration of the second network device.

In some embodiments, the apparatus 1900 further includes:
a configuration negotiation module, configured to negotiate with the first network device about the PRACH configuration of the second network device.

In some embodiments, the apparatus 1900 further includes:
a synchronization module, configured to send a synchronization signal block after entering the awake state.

In some embodiments, the second network device is a small base station within the coverage area of a macro base station.

Regarding the apparatus in the above embodiments, the specific manner in which each module performs operations has been described in detail in the embodiments of the methods, and will not be elaborated here.

The present disclosure also provides a computer storage medium storing a computer program instruction thereon, where the computer program instruction is used for. upon being executed by a processor, implementing the methods for waking up the device according to the above embodiments.

FIG. 20 is a schematic diagram of an electronic device according to an exemplary embodiment. The electronic device may be the foregoing user equipment, and may be a mobile phone, a computer, a digital broadcast terminal, a messaging device, a game console, a tablet device, a medical device, a fitness device, a personal digital assistant, etc.

Referring to FIG. 20, the electronic device 2000 may include one or more of the following components: a processing component 2002, a memory 2004, a power component 2006, a multimedia component 2008, an audio component 2010, an input/output (I/O) interface 2012, a sensor component 2014, and a communication component 2016.

The processing component 2002 generally controls the overall operation of the electronic device 2000, such as operations associated with display, phone calls, data communications, camera operations, and recording operations. The processing component 2002 may include one or more processors 2020 to execute instructions to complete all or part of the steps of the method for waking up the device. In addition, the processing component 2002 may include one or more modules to facilitate the interaction between the processing component 2002 and other components. For example, the processing component 2002 may include a multimedia module to facilitate the interaction between the multimedia component 2008 and the processing component 2002.

The memory 2004 is configured to store various types of data to support operations on the electronic device 2000. Examples of such data include instructions for any application or method operating on the electronic device 2000, contact data, phone book data, messages, pictures, videos, etc. The memory 2004 can be implemented by any type of volatile or non-volatile storage device or a combination thereof, such as statie random access memory (SRAM), electrically erasable programmable read-only memory (EEPROM), erasable programmable read-only memory (EPROM), programmable read-only memory (PROM). read-only memory (ROM), magnetic memory, flash memory, magnetic disk or optical disk.

The power component 2006 provides power to the various components of the electronic device 2000. The power component 2006 may include a power management system, one or more power supplies, and other components associated with generating, managing, and distributing power for the electronic device 2000.

The multimedia component 2008 includes a screen that provides an output interface between the electronic device 2000 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 2008 includes a front camera and/or a rear camera. When the electronic device 2000 is in an operating mode, such as a shooting mode or a video mode, the front camera and/or the rear camera may receive external multimedia data. Each front camera and the rear camera may be a fixed optical lens system or have a focal length and optical zoom capability.

The audio component 2010 is configured to output and/or input audio signals. For example, the audio component 2010 includes a microphone (MIC), and when the electronic device 2000 is in an operating mode, such as a call mode, a recording mode, and a speech recognition mode, the microphone is configured to receive an external audio signal. The received audio signal can be further stored in the memory 2004 or sent via the communication component 2016. In some embodiments, the audio component 2010 also includes a speaker for outputting audio signals.

Input/output interface 2012 provides an interface between processing component 2002 and peripheral interface modules, such as keyboards, click wheels, buttons, etc. These buttons may include, but are not limited to, a home button, a volume button, a start button, and a lock button.

The sensor assembly 2014 includes one or more sensors for providing various aspects of status assessment for the electronic device 2000. For example, the sensor assembly 2014 can detect the open/closed state of the electronic device 2000, the relative positioning of components, such as the display and keypad of the electronic device 2000. The sensor assembly 2014 can also detect the position change of the electronic device 2000 or a component of the electronic device 2000, the presence or absence of user contact with the electronic device 2000, the orientation or acceleration/deceleration of the electronic device 2000, and the temperature change of the electronic device 2000. The sensor assembly 2014 may include a proximity sensor configured to detect the presence of nearby objects without any physical contact. The sensor assembly 2014 may also include an optical sensor, such as a CMOS or CCD image sensor, for use in imaging applications. In some embodiments, the sensor assembly 2014 may. also include an acceleration sensor, a gyroscope sensor, a magnetic sensor, a pressure sensor, or a temperature sensor.

The communication component 2016 is configured to facilitate wired or wireless communication between the electronic device 2000 and other devices. The electronic device 2000 can access a wireless network based on a communication standard, such as WiFi, 2G, 3G, 4G, 5G, or the like, or a combination thereof. In an exemplary embodiment, the communication component 2016 receives a broadcast signal or broadcast-related information from an external broadcast management system via a broadcast channel. In an exemplary embodiment, the communication component 2016 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the electronic device 2000 may be implemented by one or more application-specific integrated circuits (ASICS), digital signal processors (DSPs), digital signal processing devices (DSPDs), programmable logic devices (PLDs), field programmable gate arrays (FPGAs), controllers, microcontrollers, microprocessors, or other electronic components to perform the method for waking up a device.

In an exemplary embodiment, a non-transitory computer-readable storage medium including instructions is also provided, such as the memory 2004 including instructions, where the instructions can be executed by the processor 2020 of the electronic device 2000 to perform the method for waking up a device according to the embodiments as described above. For example, the non-transitory computer-readable storage medium can be a ROM, a random access memory (RAM), a CD-ROM, a magnetic tape, a floppy disk, an optical data storage device, etc.

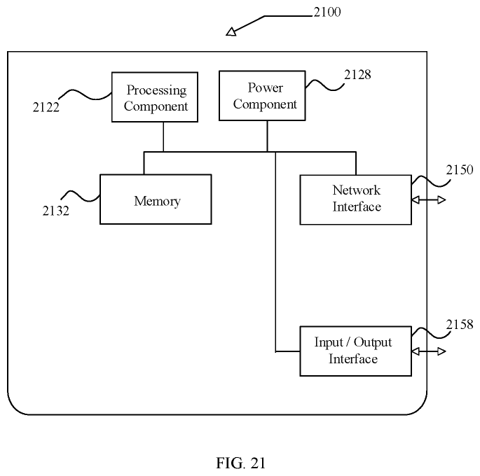

FIG. 21 is a block diagram of an electronic device according to an exemplary embodiment. The electronic device 2100 may be a network device, for example, the first network device or the second network device described above. Referring to FIG. 21, the electronic device 2100 includes a processing component 2122, which further includes one or more processors, and a memory resource represented by a memory 2132 for storing instructions executable by the processing component 2122, such as an application. The application stored in the memory 2132 may include one or more modules, each of which corresponds to a set of instructions. In addition, the processing component 2122 is configured to execute instructions to implement the method for waking up a device applied to the first network device or the second network device as described above.

The electronic device 2100 may further include a power supply component 2128 configured to perform power management of the electronic device 2100, a wired or wireless network interface 2150 configured to connect the electronic device 2100 to a network, and an input/output interface 2158.

In an exemplary embodiment, a non-transitory computer-readable storage medium including instructions is also provided, such as the memory 2132 including instructions, where the instructions can be executed by the processing component 2122 of the electronic device 2100 to implement the method for waking up a device applied to the first network device or the second network device according to the embodiments as described above. For example, the non-transitory computer-readable storage medium can be a ROM, a RAM, a CD-ROM, a tape, a floppy disk, an optical data storage device, etc.

In another exemplary embodiment, a computer program product is further provided. The computer program product includes a computer program executable by a programmable device. The computer program has a code portion used for, upon being executed by the programmable device, implementing the method for waking up the device according to the embodiments as described above.

In another exemplary embodiment, a chip is further provided, including a processor and an interface. The processor is configured to read instructions to implement the method for waking up a device according to the embodiments as described above.

Those skilled in the art will readily appreciate other embodiments of the present disclosure after considering the specification and practicing the disclosure herein. The present disclosure is intended to cover any variations, uses or adaptations of the present disclosure that follow the general principles of the present disclosure and include common knowledge or customary technique in the art that are not disclosed in the present disclosure. The description and embodiments are to be considered exemplary only, and the true scope and spirit of the present disclosure are indicated by the following claims.

It should be understood that the present disclosure is not limited to the exact construction that has been described above and shown in the drawings and that various modifications and changes may be made without departing from the scope thereof. The scope of the present disclosure is limited only by the appended claims.

1. A method for waking up a device, performed by a first network device, comprising:
sending a physical random access channel (PRACH) configuration of a second network device, wherein the PRACH configuration is configured to send, by user equipment on a PRACH of the second network device, information configured to wake up the second network device.

2. The method according to claim 1, further comprising:
sending a synchronization signal block of the first network device and sending a first parameter, wherein
the first parameter is configured to indicate the user equipment to obtain, according to the synchronization signal block of the first network device, downlink synchronization of the second network device; or
the first parameter is configured to indicate that downlink timing of the second network device is same as downlink timing of the first network device, or is configured to indicate a downlink timing difference between the second network device and the first network device.

3-4. (canceled)

5. The method according to claim 1, wherein
the PRACH configuration comprises a frequency domain resource of the PRACH channel of the second network device, the frequency domain resource comprises first offset information, and the first offset information is configured to indicate a frequency domain offset of a frequency domain starting position of the PRACH of the second network device relative to a common physical resource block 0 of the first network device; or
the PRACH configuration comprises a random access preamble sequence of the second network device, and the information configured to wake up the second network device comprises the random access preamble sequence.

6. (canceled)

7. The method according to claim 1, further comprising:
sending a wake-up delay related to the second network device.

8. The method according to claim 1, further comprising:
sending second offset information, wherein the second offset information is configured to indicate a frequency domain offset of a frequency domain position of a synchronization signal block of the second network device relative to a frequency domain position of a synchronization signal block of the first network device.

9. (canceled)

10. A method for waking up a device, performed by user equipment, comprising:
receiving a physical random access channel (PRACH) configuration of a second network device; and
sending, according to the PRACH configuration, information configured to wake up the second network device on a PRACH of the second network device.

11. The method according to claim 10, further comprising:
receiving a synchronization signal block of a first network device and receiving a first parameter; and
obtaining downlink synchronization of the second network device according to the synchronization signal block of the first network device and the first parameter.

12. The method according to claim 11, wherein obtaining downlink synchronization of the second network device according to the synchronization signal block of the first network device and the first parameter comprises:
obtaining downlink synchronization of the first network device according to the synchronization signal block of the first network device; and
obtaining the downlink synchronization of the second network device according to the downlink synchronization of the first network device and the first parameter.

13. The method according to claim 12, wherein
in response to the first parameter indicating that downlink timing of the second network device is same as downlink timing of the first network device, obtaining the downlink synchronization of the second network device according to the downlink synchronization of the first network device and the first parameter comprises: using the downlink synchronization of the first network device as the downlink synchronization of the second network device;
in response to the first parameter indicating a downlink timing difference between the second network device and the first network device, obtaining the downlink synchronization of the second network device according to the downlink synchronization of the first network device and the first parameter comprises: obtaining the downlink synchronization of the second network device according to the downlink synchronization of the first network device and the downlink timing time difference, indicated by the first parameter, between the second network device and the first network device.

14-15. (canceled)

16. The method according to claim 10, wherein the PRACH configuration comprises a frequency domain resource of the PRACH of the second network device, the frequency domain resource comprises first offset information, and the first offset information is configured to indicate a frequency domain offset of a frequency domain starting position of the PRACH of the second network device relative to a common physical resource block 0 of the first network device.

17. The method according to claim 16, further comprising:
determining the frequency domain starting position of the PRACH of the second network device according to a position of the common physical resource block 0 of the first network device and the first offset information in the PRACH configuration.

18. The method according to claim 10, wherein the PRACH configuration comprises a random access preamble sequence of the second network device; and
sending, according to the PRACH configuration, the information configured to wake up the second network device on the PRACH of the second network device comprises:
sending, on the PRACH of the second network device, the random access preamble sequence in the PRACH configuration.

19. The method according to claim 10, further comprising:
in response to not receiving a synchronization signal block sent by the second network device within a corresponding wake-up delay after sending of the information, repeating the sending of the information configured to wake up the second network device with an increased uplink transmission power.

20. The method according to claim 10, further comprising:
in response to not receiving a synchronization signal block sent by the second network device within a corresponding wake-up delay after sending of the information, sending information configured to wake up a third second network device on a PRACH of the third network device.

21-22. (canceled)

23. The method according to claim 10, further comprising:
receiving second offset information, wherein the second offset information is configured to indicate a frequency domain offset of a frequency domain position of a synchronization signal block of the second network device relative to a frequency domain position of a synchronization signal block of the first network device.

24. The method according to claim 23, further comprising:
determining the frequency domain position of the synchronization signal block of the second network device according to the second offset information; and
monitoring the synchronization signal block of the second network device at the frequency domain position of the synchronization signal block of the second network device.

25. A method for waking up a device, performed by a second network device, comprising:
entering an awake state in response to receiving, in a dormant state, information configured to wake up the second network device and sent, by user equipment according to a physical random access channel (PRACH) configuration of the second network device, on a PRACH of the second network device.

26-35. (canceled)

36. A first network device, comprising:
a processor; and
a memory, configured to store executable instructions of the processor;
wherein, the processor is configured to, upon executing the instructions, implement the method according to claim 1.

37. A user equipment, comprising:
a processor; and
a memory, configured to store executable instructions of the processor;
wherein, the processor is configured to, upon executing the instructions, implement the method according to claim 10.

38. A second network device, comprising:
a processor; and
a memory, configured to store executable instructions of the processor;
wherein, the processor is configured to, upon executing the instructions, implement the method according to claim 25.
